(19) United States
(12) Patent Application Publication
(10) Pub. No.: US 2003/0023372 A1
(43) Pub. Date: Jan. 30, 2003

(54) Road instruction information system for vehicles

(76) Inventor: Hwa-Soo Chon, Anyang-city (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/011,709

(22) Filed: Dec. 11, 2001

(30) Foreign Application Priority Data
Jul. 24, 2001 (KR) 2001-44443

(51) Int. Cl. G01C 21/34

(52) U.S. Cl. 701/211; 701/209; 340/995

(57) ABSTRACT

A road instruction information system for a vehicle is provided that provides road data to a destination point through a wireless communications network. The road instruction information system comprises a control terminal mounted in the vehicle, the control terminal transmitting road search request information through a wireless communications network, and receiving road coordinate information through the wireless communications network and informing the driver of the same through images or voice instructions; and an information center receiving the road search request information, and searching potential routes and a destination point from map data and a present position, after which the information center generates road coordinate information and transmits the same to the control terminal.

### CROSS-REFERENCE TO RELATED APPLICATION

This application claims priority of Korea patent Application No. 10-2001-0044443, filed on Jul. 24, 2001, the disclosure of which is incorporated by reference herein.

### BACKGROUND OF THE INVENTION

(a) Field of the Invention

The present invention relates to a road instruction information system for a vehicle, and more particularly, to a road instruction information system for a vehicle that uses a large database to perform a search of a present position of a vehicle, an area that the vehicle is passing through, and a path to a target destination such that the processing speed and the precision of obtained information for a vehicle navigation system are enhanced.

(b) Description of the Related Art

Traffic systems have been introduced in recent times to solve the various problems associated with the continuing increase in automobiles, in which the traffic control systems provide increased safety and traffic management using satellites, radio/TV networks, and short distance wireless communications. A prime example is the Intelligent Transportation System (ITS), which uses modern information technologies to perform the management of an existing traffic system in an intelligent and integrated manner. Accordingly, the efficiency and effectiveness of the traffic system are maximized in a given physical environment such that significant time and expense required for improvements and change to another environment may be reduced.

The ITS takes into consideration an amount of traffic, efficiency, stability, and driving pleasure of different roads and traffic situations, such that the system is urgently needed in traffic environments where there is much traffic and many accidents. An ITS that is in actual use is the Car Navigation System (CNS). The CNS uses information of the Global Positioning System (GPS) obtained from GPS satellites, direction information detected by a direction sensor, and speed information detected by a speed sensor.

In a conventional CNS, with reference to FIG. 1, a traffic information receiver 1 receives traffic information such as delay information received by an FM multiplex broadcast, a controller 2 performs various calculations and overall system control, and a map data memory 6 has stored therein map data of roads. Further, a display 7, according to display signals received from the controller 2, displays data such as a road map and traffic information. Also, a GPS receiver 8 determines a present position of the vehicle.

The controller 2 includes an image converter 3 that converts the traffic information received from the traffic information receiver 1 to generate display signals for the display of images of a road map and traffic information, and a map data reader 5 for reading map data indicated in the image converter 3 from a map data memory 6. The controller 2 also includes a central processing unit, a read only memory, a random access memory, and an input/output unit. The map data memory 6 may be a CD-ROM.

The image converter 3 also includes a traffic information display controller 4, which, in the case where traffic information received from the traffic information receiver 1 is displayed on the road map of the display 7, approximates a classification of a road corresponding to the traffic information to convert a display format of the display of traffic information. The traffic information display controller 4 is realized through a central processing unit, a read only memory, and a random access memory.

An operation of the conventional CNS structured as in the above will now be described.

If in the traffic information transmitted to the traffic information receiver 1 through a communications network there is information of delays, the traffic information display controller 4 of the controller 2 determines if the road classification corresponding to the received traffic information is a highway between cities, a highway within a city, a city street, or another type of road.

At this time, in order to display a road map, the image converter 3 instructs the map data reader 5 to read specific map data. The map data reader 5 then reads corresponding map data in the map data memory 6. Further, the image converter 3, using a delay display converted in the traffic information display controller 4, transmits a display signal to the display 7 such that delay information is displayed on the corresponding road map appearing on the display 7.

During the acquisition of traffic information, the CNS also converts a display type of traffic information other than delay information such as accident information, traffic regulation information, information of parking lot location, travel time information, etc. Accordingly, the driver has all data necessary to make driving decisions.

However, in the conventional CNS, since a map CD having road map data and a data reader are required with the mounting of the CD-ROM in the vehicle, the overall cost of the system is increased. Further, because of the constraints in the data storage capacity of the map CD, limits in the processing speed and in the precision at which traffic information is searched result.

In addition, the driver must monitor the display 7 in order to determine the present position of the vehicle. In particular, the driver must examine the road map appearing on the display 7 in detail to determine the road situation extending from the present position to the target destination. Such a distraction raises safety issues.

In addition to providing road information, the conventional CNS also performs vehicle position tracking and the transmitting and receiving of vehicle information. To realize such functions, a personal mobile communications terminal is able to access vehicle information. However, these capabilities are unable to be used if the driver does not have a personal mobile communications terminal, if the batteries in the terminal are low, or if the reception is bad.

CNS's have been developed that generate intersection data to provide precise road information with regard to intersections. To perform this operation, a paper map is scanned and map information is modulated into digital code data corresponding to the road and topography, after which numerical road data is generated. The user references the numerical road data through the monitor and inputs attributes of the road and topography to make necessary changes and additions, and to perform conversion into a navigation data map such that final intersection road data is generated. However, since multiple steps are involved after the scanning of a paper map, including changes and additions made directly by the driver, the process is complicated, inconvenient, and slow.

### SUMMARY OF THE INVENTION

The present invention has been made in an effort to solve the above problems.

It is an object of the present invention to provide a road instruction information system for a vehicle, in which a large database of an information center is accessed by a terminal mounted in the vehicle through a wireless communications network such that road searching and map image extraction is possible, thereby making a map CD and all associated costs unnecessary, and improving processing speeds and precision with regard to road searching and data extraction.

To achieve the above object, the present invention provides a road instruction information system for a vehicle comprising a control terminal mounted in the vehicle, the control terminal transmitting road search request information through a wireless communications network with respect to a destination and potential routes provided by a driver, and receiving road coordinate information through the wireless communications network with respect to map images and instruction data for road instructions; and an information center receiving the road search request information transmitted by the control terminal, and searching potential routes and a destination point from map data and a present position, after which the information center generates road coordinate information and transmits the same to the control terminal.

According to a feature of the present invention, the control terminal includes a position detector that enables the information center to determine the present position of the vehicle.

According to another feature of the present invention, the control terminal includes a display that reads and displays map images contained in the road coordinate information of the information center.

According to yet another feature of the present invention, the control terminal includes a voice output unit that reads instruction data contained in the road coordinate information of the information center and outputs voice instructions of whether there is a turn according to a turn indicator of each coordinate point.

According to still yet another feature of the present invention, the information center includes a database that stores important points in the vicinity of each road and data of maps, and a server that generates and outputs the road coordinate information from a departure point to the destination point as a result of the road search request for information of the control terminal.

According to still yet another feature of the present invention, the server includes a search server that uses data stored in the database to determine search conditions according to place names, road names, characteristic codes, and instruction codes, after which the search server performs a map request; and a map server, which, according to the map request of the search server, uses the database to generate then send to the control terminal instruction data with respect to latitude, longitude, POI, roads, intersections, and turn indicators, and the road coordinate information according to road calculation result images.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a conventional car navigation system;

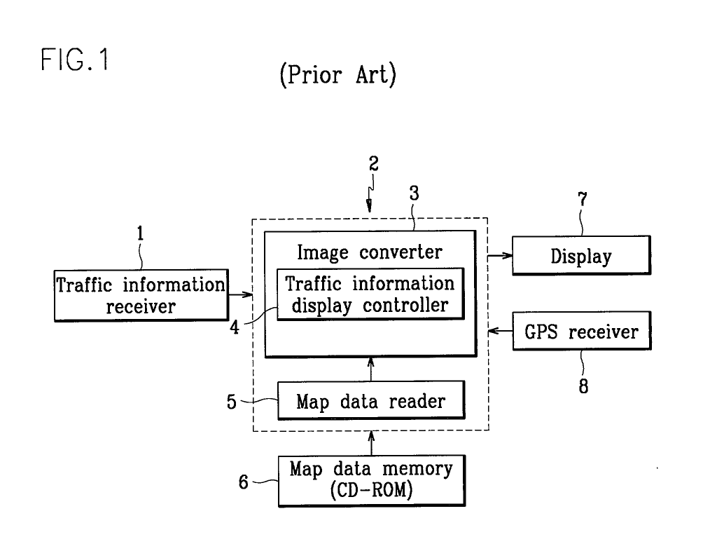

FIG. 2 is a block diagram of a road instruction information system for a vehicle according to a preferred embodiment of the present invention;

FIG. 3 is a drawing used to describe the generation of coordinate points according to road-searching by a server of FIG. 2; and

FIG. 4 is a drawing used to describe the flow of data in road-searching according to a preferred embodiment of the present invention.

### DETAILED DESCRIPTION OF THE PREFERRED EMBODIMENTS

Preferred embodiments of the present invention will now be described in detail with reference to the accompanying drawings.

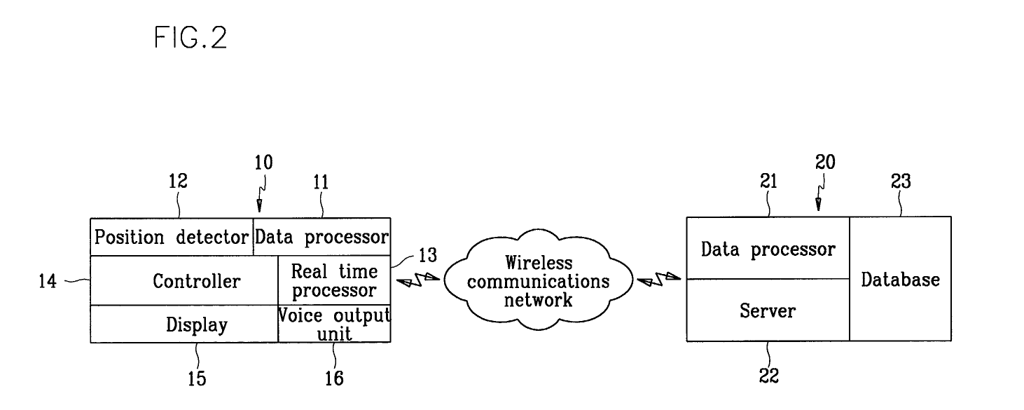

FIG. 2 is a block diagram of a road instruction information system for a vehicle according to a preferred embodiment of the present invention.

A road instruction information system for a vehicle includes a control terminal 10 mounted in the vehicle which performs the transmission and reception of information through a wireless communications network, as well as the output of images of various information and voice instructions related to the information. The system also includes an information center 20 that transmits and receives information with the control terminal 10 and provides road instruction information. The control terminal 10 and the information center 20 include data processors 11 and 21, respectively, for performing the transmission and reception of information.

If the driver inputs a target destination and a route, the control terminal 10 generates road search request information and transmits the same to the information center 20. The control terminal 10 receives road coordinate information that includes map images and instruction data, and, according to road instruction data of the information center 20, performs display or output of voice instructions.

After the reception of the road search request information from the control terminal 10, the information center 20 detects a present position of the vehicle using a GPS (global positioning system), then searches roads corresponding to map data, and the target destination and route input by the driver. The information center 20 then generates coordinate points, and outputs road coordinate information such as the place name, latitude and longitude of each coordinate point, a characteristic code, points of interest (POI), instruction codes, etc. to the control terminal 10.

In addition to the data processor 11, the control terminal 10 includes a position detector 12 that uses software to perform position tracking, and a real time processor 13 that uses a real time operating system (RTOS) to ensure precision and fast processing of transmitted and received information. Further, the control terminal 10 includes a controller 14 that controls the flow of transmitted and received information through hardware, performs analysis of various information, and controls operations of the system according to analysis results; a display 15 for performing the display of map images and road instruction data resulting from the road coordinate information and according to control by the controller 14; and a voice output unit 16 for outputting voice instructions corresponding to turn symbols of each intersection in the road coordinate information.

The control terminal 10 also includes a key input element (not shown) through which the driver inputs the target location and route, and performs control to discontinue voice instructions output through the voice output unit 16. The key input element may be a touch panel for easy manipulation by the driver, but is not limited to such a configuration.

In addition to the data processor 21, the control center 20 includes a server 22. The server 22 of the control center 20 receives the road search request information and detects the present position of the vehicle, and searches map data and roads corresponding to the departure point, potential routes, and target destination. The server 22 also generates detailed information of each coordinate point calculated along the corresponding route, that is, instruction data and road calculation result images. The control center 20 also includes a database 23 that is recorded and read by the server 22, the database 23 storing information transmitted to the server 22, as well as POI and map information.

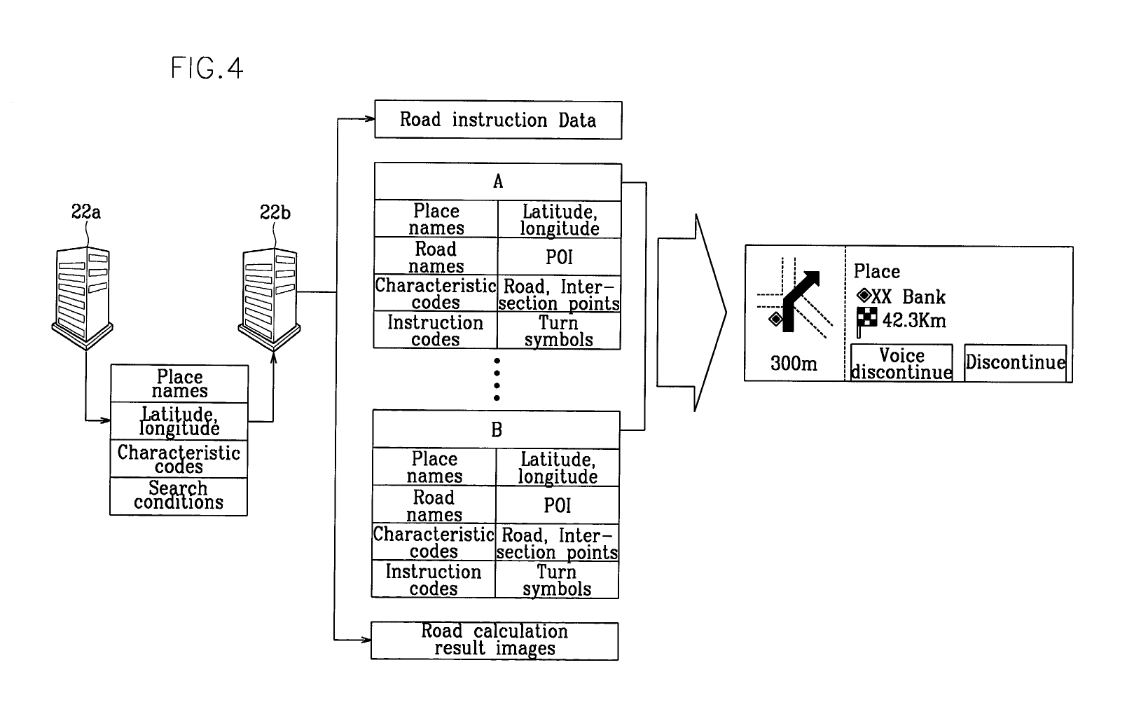

As shown in FIG. 4, the server 22 of the control center 20 includes a search server 22a that determines a target point from a departure point, and, while managing the database where POI information is stored, performs a search function and a map request function with respect to position or scaling; and a map server 22b that manages a database where map information is stored by a map request of the search server 22a, and generates map images and performs a road search function.

An operation of the road instruction information system structured as in the above will now be described.

The control terminal 10 transmits road search request information related to a target destination and potential routes, which are input by the driver, to the information center 20 through a wireless communications network. As a result, the server 22 of the information center 20 receives the road search request information and detects a present position of the vehicle by the position detector 12 of the control terminal 10.

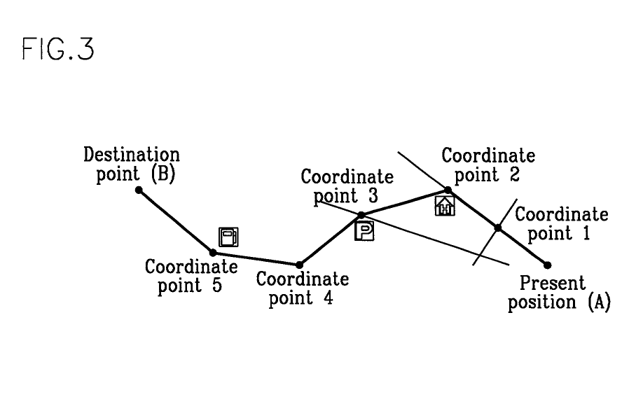

Coordinate points are generated according to road searching by the server 22 as shown in FIG. 3. That is, for example, coordinate points 1, 2, 3, 4, and 5 are calculated between a present position A and a destination point B. With reference to FIG. 4, which is used to describe the flow of data in road searching, the search server 22a uses POI information stored in the database 23 to determine coordinate point names, latitudes and longitudes, a characteristic code, and search conditions. The search server 22a then outputs a map request with respect to position and scale, to the map server 22b.

As a result, the map server 22b reads map information stored in the database 23 to search (between the present position and destination point) place names, latitudes and longitudes, road names, POIs, characteristic codes, roads and intersections, and instruction codes for turn symbols. The map server 22b then calculates road instruction data and road calculation result images, and transmits the same as road coordinate information to the control terminal 10.

The control terminal 10 receives the road coordinate information and performs control such that the road instruction data and the road calculation result images are shown on the display 15. At this time, voice instructions corresponding to turn symbols shown on the display 15 are output through the voice output unit 16. There is also a a key input region used by the driver to discontinue voice instructions, and a key input region used by the driver to discontinue display output, on the display 15.

Accordingly, in the preferred embodiment of the present invention, road searching, map images, and road instructions are calculated using the large capacity database 23 provided in the information center 20 such that the precision of the provided information and process speeds are improved. Further, a turn indicator and voice instructions are provided to the driver when a turn is imminent at an upcoming intersection, such that increased safety is provided to the driver.

In the road instruction information system for vehicles of the present invention described above, a large information center database is accessed by a terminal mounted in a vehicle through a wireless communications network such that road searching capabilities, map images, and voice instructions, which include detailed information with respect to corresponding roads, may be provided to the driver.

Further, a map CD is not required in the control terminal mounted in the vehicle such that all associated costs are reduced, and processing speeds and precision with regard to data extraction are improved. Also, by providing the user with turn symbols and voice instructions at each intersection, enhanced safety is obtained.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A road instruction information system for a vehicle comprising:
a control terminal mounted in the vehicle, the control terminal transmitting road search request information through a wireless communications network with respect to a destination and potential routes provided by a driver, and receiving road coordinate information through the wireless communications network with respect to map images and instruction data for road instructions; and
an information center receiving the road search request information transmitted by the control terminal, and searching potential routes and a destination point from map data and a present position, after which the information center generates road coordinate information and transmits the same to the control terminal.

2. The road instruction information system of claim 1 wherein the control terminal includes a position detector that enables the information center to determine the present position of the vehicle.

3. The road instruction information system of claim 1 wherein the control terminal includes a display that reads and displays map images contained in the road coordinate information of the information center.

4. The road instruction information system of claim 1 wherein the control terminal includes a voice output unit that reads instruction data contained in the road coordinate information of the information center and outputs voice instructions of whether there is a turn according to a turn indicator of each coordinate point.

5. The road instruction information system of claim 1 wherein the information center includes a database that stores important points in the vicinity of each road and data of maps, and a server that generates and outputs the road coordinate information from a departure point to the destination point as a result of the road search request for information of the control terminal.

6. The road instruction information system of claim 5 wherein the server includes a search server that uses data stored in the database to determine search conditions according to place names, road names, characteristic codes, and instruction codes, after which the search server performs a map request; and a map server, which, according to the map request of the search server, uses the database to generate then send to the control terminal instruction data with respect to latitude, longitude, POI, roads, intersections, and turn indicators, and the road coordinate information according to road calculation result images.
